(19) United States
(12) Patent Application Publication
(10) Pub. No.: US 2026/0229221 A1
(43) Pub. Date: Aug. 6, 2026

(54) KNOWLEDGE BASE FOR VOICE LARGE LANGUAGE MODEL APPLICATIONS

(71) Applicant: Salesforce, Inc., San Francisco, CA (US)

(72) Inventors: Sarath Shekkizhar, Seattle, WA (US); Romain Cosentino, Palo Alto, CA (US)

(73) Assignee: Salesforce, Inc., San Francisco, CA (US)

(21) Appl. No.: 19/097,827

(22) Filed: Apr. 1, 2025

Related U.S. Application Data
(60) Provisional application No. 63/752,613, filed on Jan. 31, 2025.

(51) Int. Cl. G10L 13/08; G06F 16/3329; G06F 16/901; G06N 5/02; G10L 15/22

(52) U.S. Cl. CPC G10L 13/08; G06F 16/33295; G06F 16/9024; G06N 5/02; G10L 15/22

(57) ABSTRACT

A voice-based agent service provides one or more voice agents to respond to voice-based requests. For example, when a question is received by the voice-based agent service it can be matched to a voice-ready knowledge base. The voice-ready knowledge base has been generated offline such that it includes concise answers without language that results in artifacts when converted to voice. These answers are organized in nodes in a conversation graph. The question can be matched to a node and then subsequent nodes can be predicted by a conversation model based on the previously traversed nodes and further user input during a real-time conversation.

### CROSS-REFERENCE TO RELATED APPLICATIONS

This application claims the benefit of U.S. Provisional Application No. 63/752,613, filed Jan. 31, 2025, which is hereby incorporated by reference.

### TECHNICAL FIELD

One or more implementations relate to the field of large language models; and more specifically, to the knowledge base for large language model applications.

### DESCRIPTION OF THE RELATED ART

The field of Artificial Intelligence (AI) focuses on the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

Large language models (LLMs) are neural networks trained to mimic human language. Specifically, LLMs are trained to predict a next token of a block of text. In operation, LLMs track relationships in sequential data by receiving tokens (e.g., words in a sentence) and predicting a next token (or sequence of tokens). Accordingly, LLMs are well suited to form conversations (e.g., taking turns asking questions and providing responses) by predicting tokens (or sequences of tokens) that are tailored to the style and context of the conversation.

LLMs have revolutionized conversation applications for the text interface. The ability to incorporate contextual information without requiring any further training, exemplified by prompting in models like OpenAI and Anthropic, has facilitated the development of text based agentic chatbots that are reliable, intelligent, and safe.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a voice-based agent service using a voice-ready knowledge base according to some example implementations.

FIG. 2 is a detailed block diagram illustrating generation of a voice-ready knowledge base according to some example implementations.

FIG. 3 is an example question and answer from a knowledge base according to some example implementations.

FIG. 4 is an example conversation flow according to some example implementations.

FIG. 5 is a flow diagram illustrating multipart question processing according to some example implementations.

FIG. 6 is a flow diagram illustrating a voice-based question answering system using a voice-ready knowledge base according to some example implementations.

FIG. 7A is a block diagram illustrating an electronic device according to some example implementations.

FIG. 7B is a block diagram of a deployment environment according to some example implementations.

### DETAILED DESCRIPTION

The following description describes implementations for voice-based question answering using a voice-ready knowledge base. While large language models have proved effective in text-based agents, they present a number of significant downsides when it comes to voice-based communication. For example, voice conversational interfaces are severely constrained by latency. A natural sounding conversation allows for latency that is in the order of 200-300 ms, i.e., given a customer audio input, a voice response from the agent typically needs to respond within a few hundred milliseconds to sound natural. Delays in the response affect the flow of the conversation and are undesirable in voice applications. Also, unlike a text-based interface, a voice interface requires agents to be concise and direct. This is because one does not have the luxury of rereading the output provided by the agent to comprehend the response when having a conversation in voice. Moreover, artifacts such as links, symbols, and abbreviations are uncommon and do not sound natural in voice responses. Further, customers building voice agentic applications do not want to handcraft every question and response that a particular agent can provide. This introduces discrepancies between the text and voice models (e.g., a text agent and a voice agent may provide different answers to the same question) and requires maintenance across multiple pipelines which drastically increases application complexity (e.g., each agent type requires its own maintenance to ensure continued accuracy, etc.).

For example, in a typical text-based system, an agent LLM receives an input from a user along with a default context set by the developer and a knowledge base that includes information to be used in answering a question posed in the input. The default context establishes the role of the agent LLM (e.g., “You are conversational AI chatbot.”). The knowledge base (KB) context is dynamic and often sets the length, amount of reasoning, and processing required by the agent LLM to generate its response. Consequently, a large KB context results in increased response time, as the model has to “attend” to a much larger input for generation. The processing time will only increase further with larger LLMs. Large KB contexts also require higher reasoning capabilities, as the model has to “attend” to various parts of its input to identify and process the right response. Larger models are typically better reasoners and more reliable for high level tasks. Large KB contexts also require additional effort to properly set the tone for the agent LLM, where a lot of unnecessary details in the KB context might result in either responses that are too long or that provide unnecessary details.

The above shortcomings are less of a problem for text interfaces as a text response can be streamed and customers are willing to “watch” an agent work through its context before a response and relevant information can be human-parsed and extracted by going through the response, multiple times if needed. However, this is not the case for voice agent responses.

Recent attempts to handle voice-based agents have used a constitution or an explicit set of voice knowledge bases. A constitutional approach sets explicit instructions in a “context prompt” to require the agent to respond in a manner consistent with voice conversations. This approach has two significant problems. It is highly unpredictable and introduces additional reasoning and processing complexity, making it unclear when the LLM is adhering to the instructions, particularly when it is fine-tuned or a private model.

In the voice knowledge base solution, a developer or customer manually writes down all input and output pairs that will be supported through the knowledge base for voice agents. This approach is time and resource intensive and is unscalable as the knowledge base expands. In addition, the agent LLM can becomes specialized to the knowledge base and can fail to generalize with the vast vocabulary that can be part of the input to the system.

In accordance with various implementations, a voice-based agent service is provided which includes voice agents that can carry out conversations with end users via a voice-ready knowledge base. The voice-ready knowledge base is created offline using a language model to break down lengthy text-based knowledge base data (e.g., articles, frequently asked questions, etc.) into conversational-sized chunks. Additionally, not all text data is readily communicated via voice. For example, symbols (e.g., #, $, @, &, etc.), web addresses, numerical codes or identifiers, etc. may be readily consumed when read, but may be difficult for the listener when read aloud. As such, the voice-ready knowledge base also ensures that the content of the knowledge base can be readily communicated via voice.

The voice-based agent service addresses the shortcomings of prior systems through the use of the voice-ready knowledge base. The voice-ready knowledge base includes conversation graph(s) where questions correspond to nodes and answers correspond to those nodes' values. During a conversation, a node is identified which corresponds to the user's question. A conversation model (e.g., a large language model or other deep learning model) can receive the question and the history of nodes that have been traversed in the conversation graph and predict a next node. This allows for questions and answers to proceed at a conversational pace, with minimal lag. Also, by reducing the size of the questions and answers, the quantity of data that must be reasoned over by the conversation model is reduced, allowing for lightweight, faster models to be used without a loss in answer accuracy.

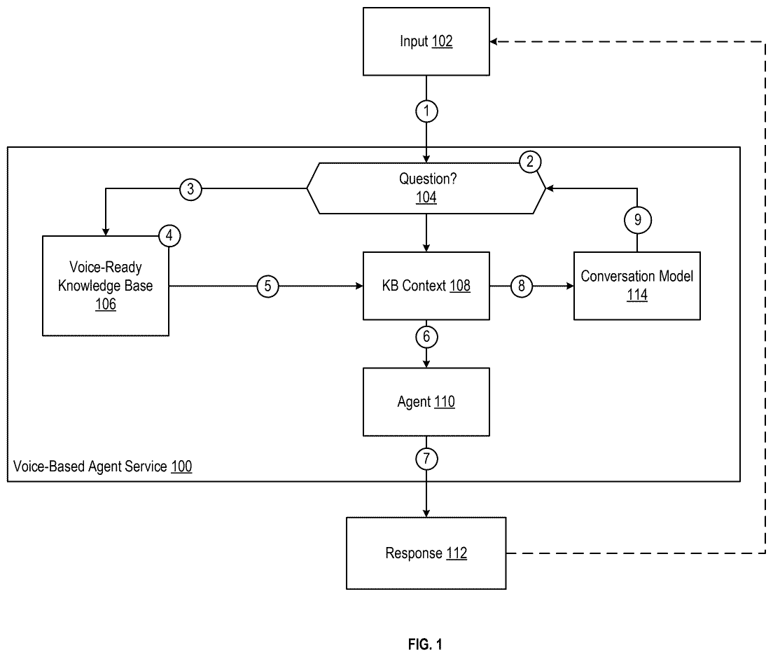

FIG. 1 is a block diagram illustrating a voice-based agent service using a voice-ready knowledge base according to some example implementations. In the implementation of FIG. 1, a voice-based agent service 100 may be an Artificial Intelligence (AI) service which hosts one or more voice agents 110 which may interact with users or other systems or entities to perform tasks. For example, an agent may be a customer service agent which answers questions received from customers (e.g., “where is my order?”, “how do I set up my router?”, “when is the pool open?”, etc.). The voice-based agent service 100 may be implemented in a cloud-based computing environment where all, or portions of, the voice-based agent service 100 are implemented on computing resources of the cloud computing environment. In some implementations, the voice-based agent service 100 may be implemented on a device, such as an onsite computer, tablet, workstation, intelligent assistant, etc. at a customer location.

The voice-based agent service 100 is LLM agnostic, allowing for integration with advancements in the language models. The approach is to be low-latency and effective for real-time systems, especially in a voice conversation setting, ensuring effective exchanges that convey the required information. Also, as noted above, the language models used can be smaller, faster models that require less resource overhead, as the voice-ready knowledge base does not require extensive reasoning over large amounts of text.

At numeral 1, the end-user may communicate with the voice-based agent service 100 via the device directly (e.g., the device may include a speaker and microphone or other audio transmission/recording devices) or via their own device (e.g., smartphone, laptop, desktop) which communicates with the voice-based agent service 100 over one or more networks, such as the Internet. This communication is input 102 which may include a question, utterance, etc. At 104, the input 102 is processed to determine if it includes a question. For example, natural language techniques may be used to parse the input 102 and determine if it includes a question 104. In some implementations, a neural network, such as an LLM or other network, may process the question and generate an embedding that represents the question. For example, a transformer-based network may generate sentence-level embedding that represents the question (e.g., a question embedding).

At numeral 3, the question embedding is provided to the voice-ready knowledge base 10t6. As discussed, the voice-ready knowledge base can include a conversation graph that includes nodes representing questions included in the knowledge base. The value of each node corresponds to an answer to that node's question. A starting node can be identified by comparing the question embedding to embeddings corresponding to each node in the voice-ready knowledge base, at numeral 4.

As shown in FIG. 1, at numeral 5, a knowledge base context 108 is formed from the question 104, and the question answer node pair retrieved from the knowledge base. This KB context 108 can be provided to the voice agent 110 at numeral 6. The voice agent 110 can include an LLM which generates a voice response 112 based on the KB context 108. This voice response is output at numeral 7.

In addition to providing the KB context 108 to the voice agent 110, the KB context is also provided to conversation model 114, at numeral 8. Conversation model 114 may include an LLM which is trained to predict a next node in the conversation graph based on the sequence of nodes that have been visited and the question/answer history. Another input may be received from the user in response to the agent's response 112 (e.g., “done”, “ok”, “what's next?”, etc.). This can be combined with the predicted next node received at numeral 9, to identify the next node in the conversation graph of the voice-ready knowledge base. For example, many different utterances may effectively mean “ok” or “next”, the embeddings for all of these utterances may be closely located within the embedding space. If the utterance embedding is close to these embeddings, then the next predicted node may be retrieved, and processing may continue in a loop until the session is complete. If, however, the embedding is closer to another node in the conversation graph, such as a different question, then processing may begin again at that new node.

For example, at any time in this flow, if a customer input 102 deviates from the flow (e.g., with a different question) the index of the node is naturally shifted to the part of the graph that directly responds to the customer while generating the next node that takes into account this departure and checks if the flow should continue.

In some implementations, the conversation model is a language model that takes as input a sequence of sentence-level embedding that maps each question corresponding to the node and generates the sentence-embedding that maps to the possible questions in the flow graph. For example, in one implementation the questions are tokenized at a sentence level with embeddings that are obtained from sentence-BERT like models. Alternatively, one can view this as a tokenization where each token corresponds to a sentence or node in the conversation flow graph, with E (the embedding mapping) obtained using a sentence-level embedding.

Given a sequence of embeddings, the training of the model and generation follows a similar setup as standard language model training. However, since a typical conversation flow graph is limited to nodes of in the order of tens or at max hundreds, the model required to map these tokens can be small and efficiently obtained for any given article or domain. Moreover, this approach allows one to share the models across different graphs given enough overlap in terms of their node embeddings or can be fine-tuned from a base node mapping model. The training objective for the conversation model uses a cross-entropy loss as below with the embedding layer frozen.

$$- {\sum }_{v = 1}^{V} {t}_{T + 1}^{( v )} ( {x}_{1 : T}^{{}_{l}} ) log {\hat{t}}_{T + 1}^{{}_{( v )}} ( {y}_{1 : T}^{l} )$$

In particular, implementations make use of the fact that LLM generation is equivalent to a walk on the manifold, except that implementations modify the manifold to be that of sentences. An [END_OF_SENTENCE] embedding corresponds to the termination of the flow.

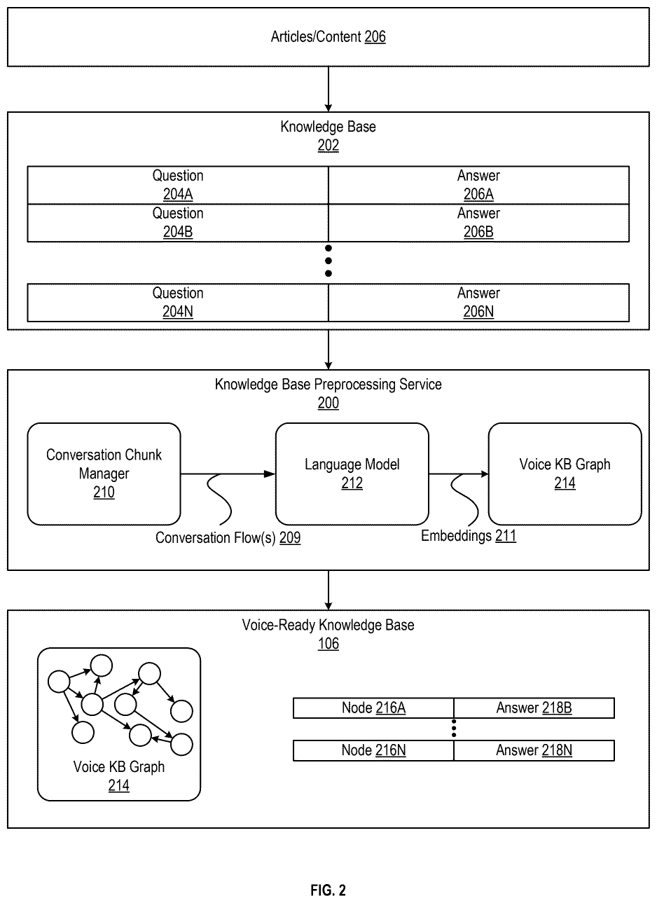

FIG. 2 is a detailed block diagram illustrating generation of a voice-ready knowledge base according to some example implementations. As shown in FIG. 2, a knowledge base preprocessing service 200 is responsible for generating a voice-ready knowledge base 106 from an existing knowledge base 202. A knowledge base 202 may include a collection of questions 204A-N and corresponding answers 206A-N which have been extracted from various content sources 208, such as articles, frequently asked questions, etc. A knowledge base may be domain specific, customer specific, question specific, etc. That is, the precise contents of the knowledge base may be dynamic, increasing or decreasing depending on the scope of questions it is to be used to answer.

As discussed, to be effective for voice, answers need to be short and concise (e.g., typically 100 words or fewer) and only include information that can be readily communicated via voice (e.g., no symbols, numeric codes, web addresses, etc.). However, a typical knowledge base is robust, including lengthy instructions, detailed answers, links to more information, etc. While this is effective for text-based interfaces where the user can read the answer and return to it multiple times if needed, for voice such lengthy and detailed answers typically lead to a poor user experience.

In accordance with various implementations, to generate a voice-ready knowledge base, the existing knowledge base 202 is preprocessed offline. This allows conversational flows to be created that take into account the information presented in the knowledge base 202. Additionally, the conversational flows are embedded in an easy-to-retrieve setting where one can jump into any part of the conversation flow during runtime. This will be accomplished by leveraging the geometric understanding of the embeddings corresponding to text knowledge base articles that capture the conversational patterns in a voice application.

Large language models (LLMs) process input text and generate responses through a sequence of operations with tokenization and transformer layers. The input text is split into tokens t₁, t₂, . . . , t_{T} the basic unit of processing for LLMs, and mapped to vector embeddings, each ∈R^{d},

$${\hat{t}}_{T + 1} := LLM ( {t}_{1 : T} ) = softmax ( {E}^{T} [ {ℱ}^{L} ⊙ {ℱ}^{L - 1} … {ℱ}^{l} … {ℱ}^{1} ] {Et}_{1 : T} )$$

where E corresponds to the embedding mapping and [symbol] corresponds to the transformer [symbol] mapping at each layer. Each transformer layer then processes this input embedding such that the embedding at the final layer can be decoded as the next token prediction given the input text.

In some implementations, the transformer layers maintain the embedding dimension, e.g., given x₁, x₂, . . . , x_{T}, each layer of transformation maintains the embedding dimension, e.g., ∈R^{d}.

$${x}_{i}^{{}_{l + 1}} = {ℱ}^{l} ( {x}_{i}^{l} ) , i ∈ \{ 1 , … T \} , l ∈ \{ 1 , … L \}$$

Thus, the mapping associated with the LLM can be viewed as a manifold walk or an acyclic graph flow that continues the input in the embedding representation space.

As shown in FIG. 2, the knowledge base preprocessing service 200 can receive question and answer pairs from the knowledge base 202. The knowledge base preprocessing service 200 can create the voice-ready knowledge base by dividing the knowledge base into a conversation graph comprising a plurality of nodes. As discussed, a given knowledge base can include data from many different articles or other content sources. In some implementations, the knowledge base preprocessing service 200 receives data corresponding to a single article or content source at a time and generates conversation graph(s) for that article before moving on to other articles or content sources included in the knowledge base.

In some implementations, knowledge base preprocessing service 200 includes a conversation chunk manager 210 which divides the knowledge base data into short, concise chunks which will each be represented by a node from a set of nodes. Each node represents a short concise sentence that is voice appropriate, e.g., without non-speech artifacts (symbols, numerical codes, web addresses, and the like). Connections between the nodes represent a schema of conversation that can happen around the sentences available in the article. Note that the index to these nodes are questions/inputs while the nodes themselves represent a value that is a response or output. At runtime, as discussed, an input question can be matched to an index corresponding to one of the nodes in the graph (e.g., by comparing embeddings) and the matching node's value is used to generate a response and an index to the next node in the flow. In some implementations, the conversation chunk manager 210 is implemented as a language model or other neural network which has been trained to receive input text and output voice ready text.

In some implementations, the resulting conversation flows 209 are then provided to language model 212. Language model 212 can process each node and generate a corresponding embedding representing that node in an embedding space. The language model 212 can be a transformer-based model trained to generate sentence level embeddings or other neural network. The embeddings 211 are combined with the conversation flows to make a voice knowledge base graph 214. In this way, the embeddings act as an index for the questions covered by the knowledge base. As discussed, at runtime, when a question is received, it can similarly be processed to generate an embedding. The question embedding can then be matched to the embeddings in the voice knowledge base graph 214 index to find the most similar question (e.g., using cosine similarity, or other distance or similarity metric). That corresponding node then acts as the starting point for the conversation with the user. For example, as shown in FIG. 2, voice-ready knowledge base 106 includes the voice knowledge base graph 214 together with an index of nodes 216A-N and answers 218A-N

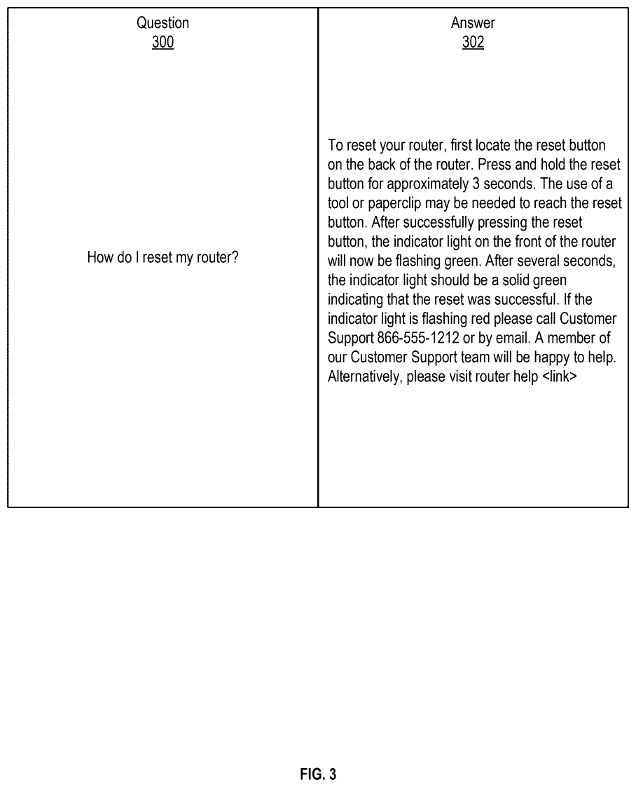

FIG. 3 is an example question and answer from a knowledge base according to some example implementations. As discussed, a knowledge base may include a number of questions 300 and answers 302. In the example of FIG. 3, a single question-answer pair is shown for simplicity. Here, the question 300 “how do I reset my router?” is paired with a lengthy answer walking the user through the procedure to reset their router. As discussed, such a lengthy answer being read out by a voice agent would lead to a poor user experience.

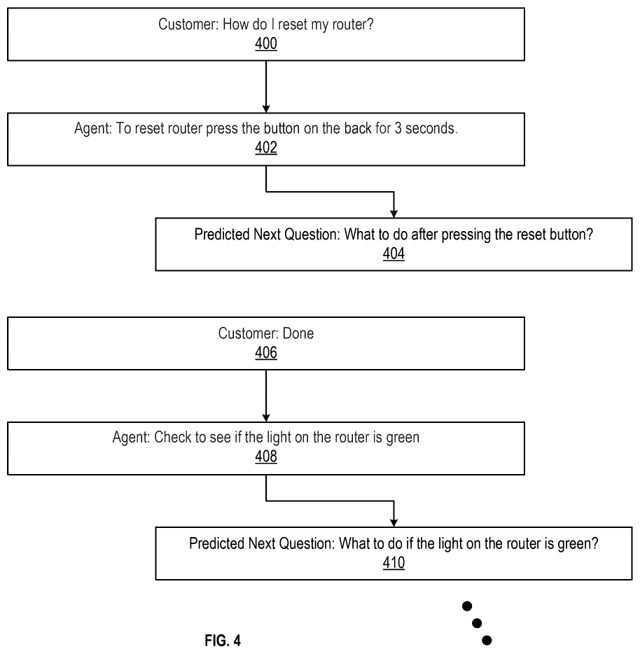

FIG. 4 is an example conversation flow according to some example implementations. FIG. 4 shows an example result of the knowledge base of FIG. 3 being converted into a voice-ready knowledge base. For example, the customer can provide question 400 “how to I reset my router”. This is matched to the “how do I reset my router” node in the voice ready knowledge base, using the techniques described herein. The agent then responds with the answer 402 “to reset your router press the button on the back for 3 seconds”. Thus the answer is reduced from multiple sentences into a single concise instruction. Additionally, the predicted next question 404 (e.g., node) is “what to do after pressing the reset button”. The customer then responds 406 “done”. Processing then proceeds to the predicted next node and provides the answer 408 “check to see if the light on the router is green”, with the predicted next node 410 being “what to do if the light on the router is green?”.

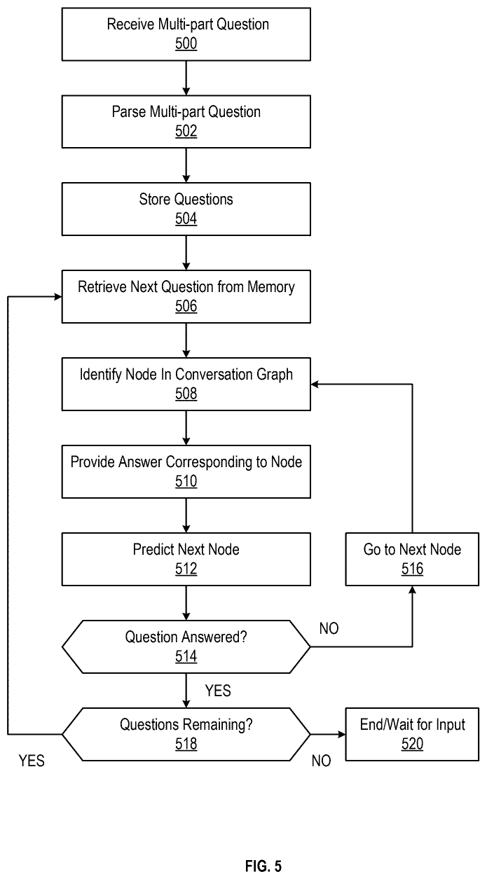

FIG. 5 is a flow diagram illustrating multipart question processing according to some example implementations. In the above examples, a single question is received at a time. However, in practice users are not limited to asking a single question at a time. Instead, they may ask multipart questions where each part may or may not be related. In such instances, the voice-based agent service may process each question separately, as discussed.

For example, at step 500 a multipart question is received by the voice-based agent service. The multipart question is then parsed into separate questions at step 502. In some implementations, each question may be processed to generate a corresponding embedding. The questions and corresponding embeddings can be stored at step 504. Each question can then be processed in turn. At step 506, the voice-based agent service retrieves the next question from memory. The question can then be matched to a node in the conversation graph in the voice-ready knowledge base at step 508. As discussed, this match may be performed based on embeddings corresponding to the question and the nodes in the conversation graph (e.g., using cosine similarity, or other distance or similarity metric). The corresponding answer can then be presented to the user at step 510 and the next node can be predicted at step 512.

At step 514, the voice-based agent service can determine if the question has been answered. If not, then at step 516 the processing can go to the next node (e.g., the predicted node) in the conversation graph and processing can continue from step 508. If the predicted next node corresponds to END_SENTENCE, then the answer can be considered answered. The voice-based agent service can then check the memory to determine whether any questions remain at step 518. If there are additional questions, then processing can return to step 506 and the next question can be processed. If no questions remain then at step 520 processing can end or the agent can wait for further input.

Additionally, as discussed, at any point the user can provide additional input (e.g., a new question) which may reset processing to the node corresponding to the new question.

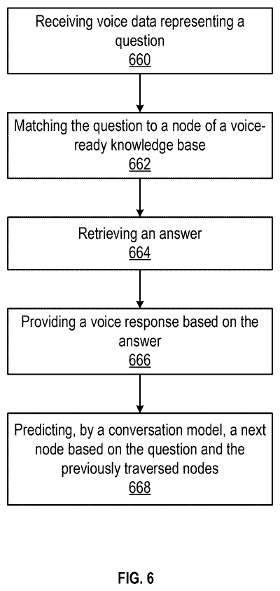

FIG. 6 is a flow diagram illustrating a voice-based question answering system using a voice-ready knowledge base according to some example implementations. In one or more implementations, the method is performed in a digital medium environment that includes the voice-based agent service 100.

As illustrated in FIG. 6, the method includes an act 660 of receiving, by a voice artificial intelligence service, voice data representing a question. As discussed, the voice data can be received from an end user, customer, other system, service, or entity.

As illustrated in FIG. 6, the method also includes an act 662 of identifying a node in a conversation graph of a voice-ready knowledge base corresponding to the question. As discussed, an embedding can be generated for the question when it is received. It can then be compared to embeddings in an index in the voice-ready knowledge base to identify a starting node in a conversation graph. The embeddings may be matched using cosine similarity or other similarity or distance metric.

As illustrated in FIG. 6, the method also includes an act 664 of retrieving an answer based on the node. As discussed, the value of the node may include the text of the answer. The answer may be a concise, voice-ready version of a longer answer from a pre-existing knowledge base, as discussed.

As illustrated in FIG. 6, the method also includes an act 666 of providing a voice response corresponding to the answer. For example, the answer may be provided to a voice agent along with the question, which may then generate a voice response that is returned to the questioner. As discussed, the question and answering may be performed in real-time, approximating the timing of a real conversation with a human agent.

As illustrated in FIG. 10, the method also includes an act 1060 of predicting, by a conversation model, a next node in the conversation graph based at least on the question and the node. In some implementations, the conversation model predicts the next node based on a question history and a node history.

As discussed, processing may continue until the question has been fully answered. For example, a given question may be broken down into a series of sub-questions and corresponding answers that fully describe a sequence of operations. When new voice data is received representing an utterance, a second answer can be retrieved based on the next node and the utterance. A second voice response corresponding to the second answer can then be returned to the questioner. In some implementations, this processing may continue by iteratively processing one or more additional next nodes until a last predicted next node corresponds to an end sentence embedding.

In some implementations, the voice-ready knowledge base is generated offline by a knowledge base preprocessing service based at least on a knowledge base comprising a plurality of text content sources. The knowledge base preprocessing service can generate a conversation graph comprising a plurality of nodes, wherein each node corresponds to a voice-ready question generated by a language model based at least on the knowledge base. The knowledge base preprocessing service can also generate an embedding corresponding to each node and combine the conversation graph with the embeddings to generate the voice-ready knowledge base.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

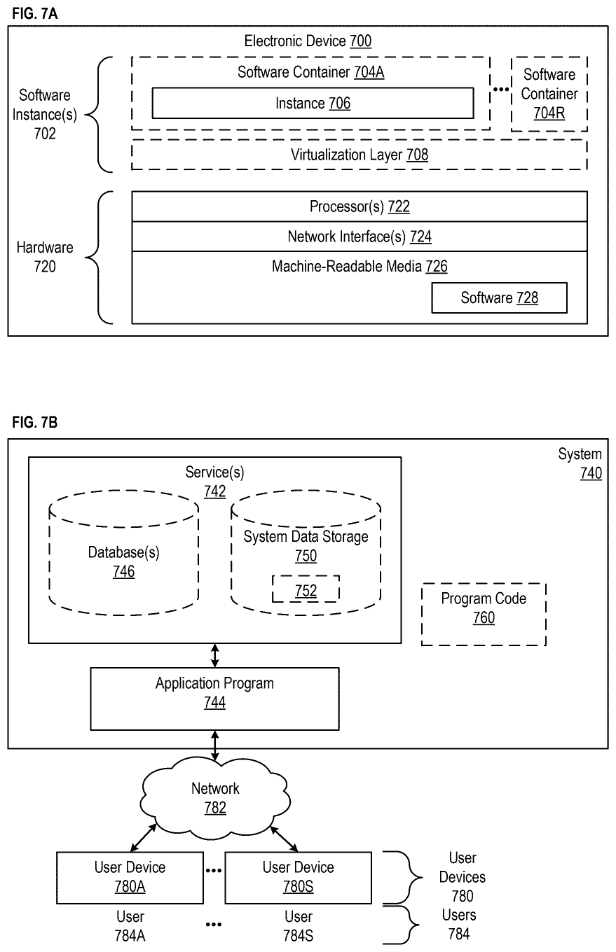

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 726 may include non-transitory and/or transitory machine-readable media. Each of the previously described clients and the voice-based agent service may be implemented in one or more of electronic device 700. In one implementation: 1) each of the clients is implemented in a separate one of the electronic device 700 (e.g., in end user devices where the software 728 represents the software to implement clients to interface directly and/or indirectly with the voice-based agent service (e.g., software 728 represents a web browser, a native client, a portal, a command-line interface, and/or an application programming interface (API) based upon protocols such as Simple Object Access Protocol (SOAP), Representational State Transfer (REST), etc.)); 2) the voice-based agent service is implemented in a separate set of one or more of electronic device 700 (e.g., a set of one or more server devices where the software 728 represents the software to implement the voice-based agent service); and 7) in operation, the electronic devices implementing the clients and the voice-based agent service would be communicatively coupled (e.g., by a network) and would establish between them (or through one or more other layers and/or or other services) connections for submitting voice inputs (e.g., questions) to the voice-based agent service and returning voice responses (e.g., answers) to the clients. Other configurations of electronic devices may be used in other implementations (e.g., an implementation in which the client and the voice-based agent service are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and a set of one or more software containers, shown as software container 704A to software container 704R (e.g., with operating system-level virtualization, the virtualization layer 708 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. Instances of the software 728, as well as the virtualization layer 708 and the software containers if implemented, are collectively referred to as software instance(s) 702.

Alternative implementations of an electronic device may have numerous variations from that described above. For example, customized hardware and/or accelerators might also be used in an electronic device.

### Example Environment

FIG. 7B is a block diagram of a deployment environment according to some example implementations. A system 740 includes hardware (e.g., a set of one or more server devices) and software to provide service(s) 742, including the voice-based agent service. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 740 is coupled to user devices 780 (shown as user device 780A to user device 780S) over a network 782. The service(s) 742 may be on-demand services that are made available to users 784 (shown as user 784A to user 784S) working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users). The service(s) 742 may communicate with each other and/or with one or more of the user devices 780 via one or more APIs (e.g., a REST API). In some implementations, the user devices 780 are operated by the users 784, and each may be operated as a client device and/or a server device. In some implementations, one or more of the user devices 780 are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 740 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 740 may include an application platform 744 that enables PAAS for creating, managing, and executing one or more applications developed by the provider of the application platform 744, users accessing the system 740 via one or more of the user devices 780, or third-party application developers accessing the system 740 via one or more of user devices 780.

In some implementations, one or more of the service(s) 742 may use one or more database(s) 746 and/or system data storage 750 (which stores system data 752). In certain implementations, the system 740 includes a set of one or more servers that are running on server electronic devices and that are configured to handle requests for any authorized user associated with any tenant (there is no server affinity for a user and/or tenant to a specific server). The user devices 780 communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the database(s) 746 and/or system data storage 750.

In some implementations, the service(s) 742 are implemented using virtual applications dynamically created at run time responsive to queries from the user devices 780 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the voice-based agent service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 7rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780.

Each of the user devices 780 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784 to interact with various GUI pages that may be presented to the one or more of users 784. The user devices 780 may communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 780 may include an HTTP client, commonly referred to as a “browser,” for sending and receiving HTTP messages to and from server(s) of system 740, thus allowing one or more of the users 784 to access, process and view information, pages and applications available from system 740 over network 782.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, if executed by a processor the processor to perform operations comprising:
receiving, by a voice-based agent service, voice data representing a question;
identifying a node in a conversation graph of a voice-ready knowledge base corresponding to the question;
retrieving an answer based on the node;
providing a voice response corresponding to the answer; and
predicting, by a conversation model, a next node in the conversation graph based at least on the question and the node.

2. The non-transitory machine-readable storage medium of claim 1, wherein the operations further comprise:
receiving new voice data representing an utterance;
retrieving a second answer based on the next node and the utterance; and
providing a second voice response corresponding to the second answer.

3. The non-transitory machine-readable storage medium of claim 2, wherein the operations further comprise:
iteratively processing one or more additional next nodes until a last predicted next node corresponds to an end sentence embedding.

4. The non-transitory machine-readable storage medium of claim 1, wherein the voice-ready knowledge base is generated offline by a knowledge base preprocessing service based at least on a knowledge base comprising a plurality of text content sources.

5. The non-transitory machine-readable storage medium of claim 4, wherein the knowledge base preprocessing service:
generates a conversation graph comprising a plurality of nodes, wherein each node corresponds to a voice-ready question generated by a language model based at least on the knowledge base;
generates an embedding corresponding to each node; and
combines the conversation graph with the embeddings to generate the voice-ready knowledge base.

6. The non-transitory machine-readable storage medium of claim 1 wherein the operation of identifying a node in a conversation graph of a voice-ready knowledge base corresponding to the question further comprises:
generating an question embedding for the question; and
matching the question embedding to a node embedding using a similarity metric.

7. The non-transitory machine-readable storage medium of claim 1, wherein the conversation model predicts the next node based on a question history and a node history.

8. A method comprising:
receiving, by a voice-based agent service, voice data representing a question;
identifying a node in a conversation graph of a voice-ready knowledge base corresponding to the question;
retrieving an answer based on the node;
providing a voice response corresponding to the answer; and
predicting, by a conversation model, a next node in the conversation graph based at least on the question and the node.

9. The method of claim 8, further comprising:
receiving new voice data representing an utterance;
retrieving a second answer based on the next node and the utterance; and
providing a second voice response corresponding to the second answer.

10. The method of claim 9, further comprising:
iteratively processing one or more additional next nodes until a last predicted next node corresponds to an end sentence embedding.

11. The method of claim 8, wherein the voice-ready knowledge base is generated offline by a knowledge base preprocessing service based at least on a knowledge base comprising a plurality of text content sources.

12. The method of claim 11, wherein the knowledge base preprocessing service:
generates a conversation graph comprising a plurality of nodes, wherein each node corresponds to a voice-ready question generated by a language model based at least on the knowledge base;
generates an embedding corresponding to each node; and
combines the conversation graph with the embeddings to generate the voice-ready knowledge base.

13. The method of claim 8 wherein identifying a node in a conversation graph of a voice-ready knowledge base corresponding to the question further comprises:
generating an question embedding for the question; and
matching the question embedding to a node embedding using a similarity metric.

14. The method of claim 8, wherein the conversation model predicts the next node based on a question history and a node history.

15. An apparatus comprising:
a processor or set of one or more processors; and
a non-transitory machine-readable storage medium that provides instructions that, if executed by the processor, are configurable to cause the apparatus to perform operations comprising,
receiving, by a voice-based agent service, voice data representing a question;
identifying a node in a conversation graph of a voice-ready knowledge base corresponding to the question;
retrieving an answer based on the node;
providing a voice response corresponding to the answer; and
predicting, by a conversation model, a next node in the conversation graph based at least on the question and the node.

16. The apparatus of claim 15, wherein the operations further comprise:
receiving new voice data representing an utterance;
retrieving a second answer based on the next node and the utterance; and
providing a second voice response corresponding to the second answer.

17. The apparatus of claim 16, wherein the operations further comprise:
iteratively processing one or more additional next nodes until a last predicted next node corresponds to an end sentence embedding.

18. The apparatus of claim 15, wherein the voice-ready knowledge base is generated offline by a knowledge base preprocessing service based at least on a knowledge base comprising a plurality of text content sources.

19. The apparatus of claim 18, wherein the knowledge base preprocessing service:
generates a conversation graph comprising a plurality of nodes, wherein each node corresponds to a voice-ready question generated by a language model based at least on the knowledge base;
generates an embedding corresponding to each node; and
combines the conversation graph with the embeddings to generate the voice-ready knowledge base.

20. The apparatus of claim 15 wherein the operation of identifying a node in a conversation graph of a voice-ready knowledge base corresponding to the question further comprises:
generating an question embedding for the question; and
matching the question embedding to a node embedding using a similarity metric.
